(19) United States
(12) Patent Application Publication
(10) Pub. No.: US 2010/0139446 A1
(43) Pub. Date: Jun. 10, 2010

(54) Car Gear Lever Assembly Having A Lighting or Blinking Effect

(76) Inventors: Kun-Wang Wang, Tainan City (TW); Pi-Jie Lu, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/330,974

(22) Filed: Dec. 9, 2008

(51) Int. Cl. B60K 20/02; F16H 59/02; F21V 33/00

(52) U.S. Cl. 74/523; 362/253

(57) ABSTRACT

A gear lever assembly for a car includes a gear lever, a support unit, a control unit and a power supply unit. The support unit includes a housing, a transparent body, a sphere, an electric wire, and an insulating member. The control unit is used to control operation of the sphere and the electric wire. The power supply unit is used to provide an electric power to the electric wire. The sphere produces a blink (or light) by operation of a high voltage static electricity. The insulating member is enclosed around the electric wire to prevent from incurring a static electricity leakage from the housing and the transparent body so as to prevent the static electricity from interfering with operation of the electronic systems in the car.

### BACKGROUND OF THE INVENTION

1. Field of the Invention

The present invention relates to a gear lever assembly and, more particularly, to a gear lever assembly for a wheeled vehicle, such as a car and the like.

2. Description of the Related Art

A conventional gear lever is mounted in a car to change the speed of the car. An ornament can be mounted on the gear lever to enhance the outer appearance of the gear lever. However, the ornament cannot provide a lively viewing effect to the driver, thereby limiting the utility of the ornament, and thereby limiting the aesthetic quality of the gear lever.

### BRIEF SUMMARY OF THE INVENTION

In accordance with the present invention, there is provided a gear lever assembly, comprising: a gear lever, a support unit, a control unit and a power supply unit. The support unit includes a housing mounted on the gear lever, a transparent body mounted on the housing, a sphere mounted between the housing and the transparent body, an electric wire mounted between the housing and the transparent body and having a first end electrically connected to the sphere to produce a static electricity, and an insulating member mounted between the housing and the transparent body and enclosed around the electric wire to prevent from incurring a static electricity leakage from the housing and the transparent body. The control unit is mounted on the housing of the support unit to control operation of the sphere and the electric wire of the support unit. The power supply unit is mounted on the housing of the support unit and electrically connected to the control unit to provide an electric power to the electric wire of the support unit by operation of the control unit.

The primary objective of the present invention is to provide a car gear lever assembly having a lighting or blinking effect.

Another objective of the present invention is to provide a gear lever assembly for a car, wherein the sphere of the support unit produces a blink (or light) by operation of the high voltage static electricity, thereby enhancing the aesthetic quality of the gear lever assembly, and thereby providing a lively and outstanding sensation to the user.

A further objective of the present invention is to provide a gear lever assembly for a car, wherein the insulating member of the support unit is enclosed around the electric wire to prevent from incurring a static electricity leakage from the housing and the transparent body to prevent the static electricity from interfering with operation of the electronic systems in the car.

A further objective of the present invention is to provide a gear lever assembly for a car, wherein the circuit board of the control unit functions to isolate and regulate the static electricity to prevent the static electricity from interfering with operation of the electronic systems in the car.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front cross-sectional view of a gear lever assembly for a car in accordance with the preferred embodiment of the present invention.

FIG. 2 is a schematic operational view of the gear lever assembly for a car as shown in FIG. 1 in use.

FIG. 3 is a front view of a gear lever assembly for a car in accordance with another preferred embodiment of the present invention.

### DETAILED DESCRIPTION OF THE INVENTION

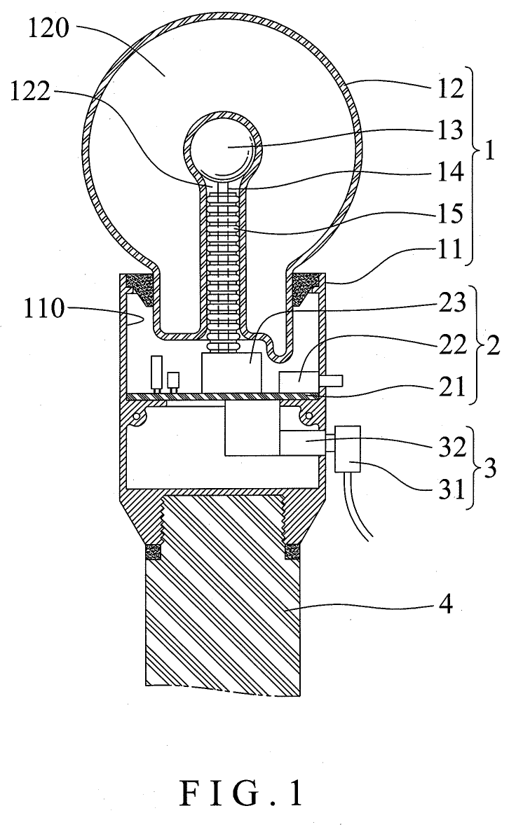

Referring to the drawings and initially to FIG. 1, a gear lever assembly for a car in accordance with the preferred embodiment of the present invention comprises a gear lever 4, a support unit 1, a control unit 2 and a power supply unit 3.

The support unit 1 includes a housing 1 mounted on the gear lever 4, a transparent body 12 mounted on the housing 11, a sphere 13 mounted between the housing 11 and the transparent body 12, an electric wire 14 mounted between the housing 11 and the transparent body 12 and having a first end electrically connected to the sphere 13 to produce a static electricity, and an insulating member 15 mounted between the housing 11 and the transparent body 12 and enclosed around the electric wire 14 to prevent from incurring a static electricity leakage from the housing 11 and the transparent body 12. The housing 11 of the support unit 1 has a lower end secured on the gear lever 4 and an upper end provided with an opening 110 for mounting the transparent body 12. The transparent body 12 of the support unit 1 has a substantially spherical profile and has an inner portion provided with a receiving chamber 120 to receive an insert gas. The transparent body 12 of the support unit 1 has a side provided with an elongate receiving space 122 to receive the sphere 13, the electric wire 14 and the insulating member 15. The receiving space 122 of the transparent body 12 is connected to the opening 110 of the housing 11. The receiving space 122 of the transparent body 12 extends from a periphery of the transparent body 12 to a center of the transparent body 12 and is encompassed by the receiving chamber 120. The sphere 13 of the support unit 1 is located at a central portion of the transparent body 12 and is encompassed by the insert gas of the receiving chamber 120 of the transparent body 12.

The control unit 2 is mounted on the housing 11 of the support unit 1 to control operation of the sphere 13 and the electric wire 14 of the support unit 1. The control unit 2 includes a circuit board 21 mounted in the housing 11 of the support unit 1 and electrically connected to the electric wire 14 of the support unit 1, a transformer 23 mounted in the housing 11 of the support unit 1 and electrically connected between the circuit board 21 and a second end of the electric wire 14 of the support unit 1 to regulate the current and voltage from the circuit board 21 to the electric wire 14 of the support unit 1, and a control switch 22 mounted on the housing 11 of the support unit 1 and electrically connected to the circuit board 21 to turn on/off an electric connection between the circuit board 21 and the electric wire 14 of the support unit 1. The circuit board 21 of the control unit 2 functions to isolate and regulate the static electricity. The transformer 23 of the control unit 2 is located above the circuit board 21 of the control unit 2.

The power supply unit 3 is mounted on the housing 11 of the support unit 1 and electrically connected to the control unit 2 to provide an electric power to the electric wire 14 of the support unit 1 by operation of the control unit 2. The power supply unit 3 includes a socket 32 mounted in the housing 11 of the support unit 1 and electrically connected to the circuit board 21 of the control unit 2, and a plug 31 detachably mounted on the housing 11 of the support unit 1 and electrically connected to the socket 32 to provide an electric power through the socket 32 into the circuit board 21 of the control unit 2. The plug 31 of the power supply unit 3 is electrically connected to a power supply device of the car, such as the cigarette lighter, the battery and the like. The socket 32 of the power supply unit 3 is located under the circuit board 21 of the control unit 2.

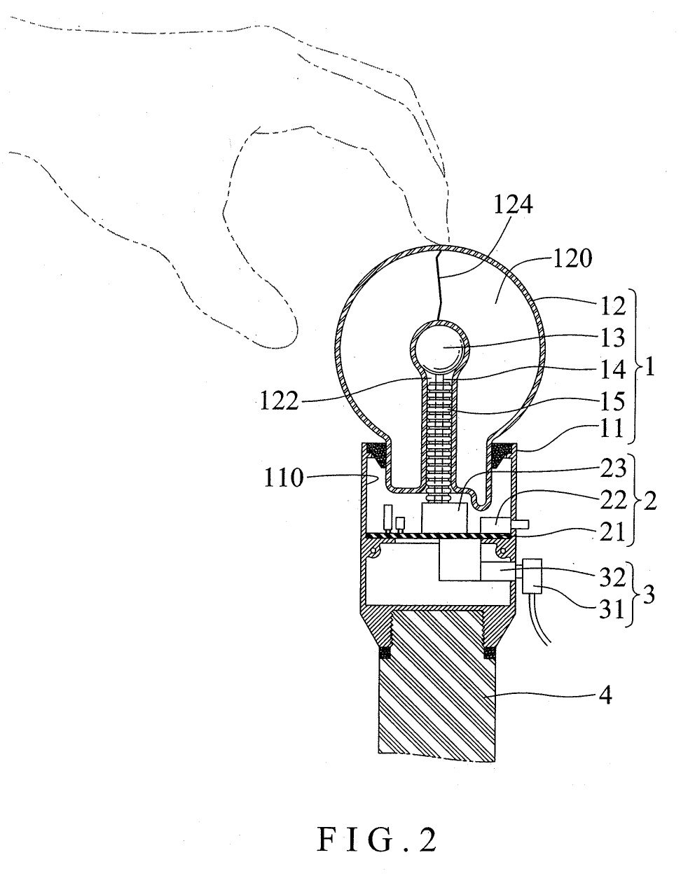

In operation, referring to FIG. 2 with reference to FIG. 1, the plug 31 of the power supply unit 3 is inserted into the socket 32 of the power supply unit 3 to provide an electric power through the socket 32 of the power supply unit 3 into the circuit board 21 of the control unit 2. In such a manner, when the circuit board 21 of the control unit 2 is energized by operation of the control switch 22 of the control unit 2, the circuit board 21 of the control unit 2 provides an electric power to the electric wire 14 of the support unit 1. At this time, the sphere 13 of the support unit 1 contacts the electric wire 14 of the support unit 1 to produce a high voltage static electricity. Thus, when a user's hand touches the transparent body 12 of the support unit 1, the high voltage static electricity of the sphere 13 of the support unit 1 is activated, so that a reaction is produced between the high voltage static electricity of the sphere 13 of the support unit 1 and the insert gas of the receiving chamber 120 of the transparent body 12 by touch of the user's hand, so as to produce a blink 124 (or light) in the receiving chamber 120 of the transparent body 12, thereby greatly enhancing the aesthetic quality of the gear lever assembly, and thereby providing a lively and outstanding sensation to the user.

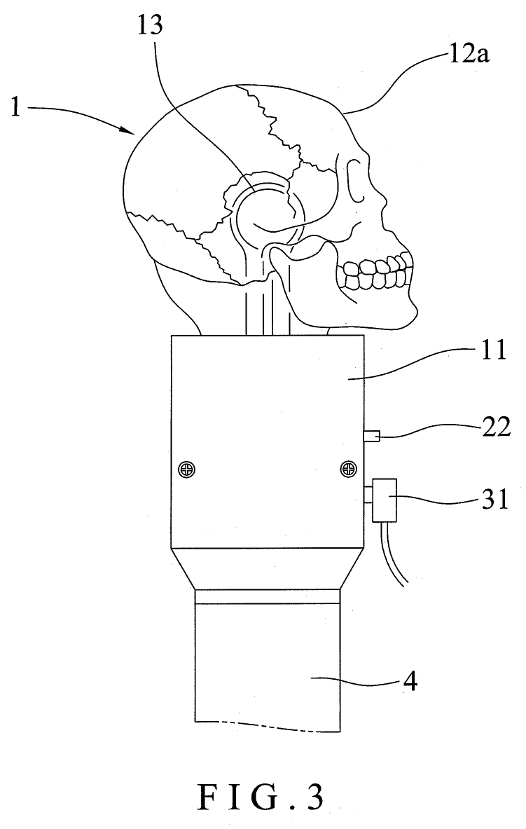

As shown in FIG. 3, the transparent body 12 of the support unit 1 has a different shape, such as the shape of a skull.

Accordingly, the sphere 13 of the support unit 1 produces a blink 124 (or light) by operation of the high voltage static electricity, thereby enhancing the aesthetic quality of the gear lever assembly, and thereby providing a lively and outstanding sensation to the user. In addition, the insulating member 15 of the support unit 1 is enclosed around the electric wire 14 to prevent from incurring a static electricity leakage from the housing 11 and the transparent body 12 to prevent the static electricity from interfering with operation of the electronic systems in the car. Further, the circuit board 21 of the control unit 2 functions to isolate and regulate the static electricity to prevent the static electricity from interfering with operation of the electronic systems in the car.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A gear lever assembly, comprising: a gear lever, a support unit, a control unit and a power supply unit, wherein:
the support unit includes:
a housing mounted on the gear lever;
a transparent body mounted on the housing;
a sphere mounted between the housing and the transparent body;
an electric wire mounted between the housing and the transparent body and having a first end electrically connected to the sphere to produce a static electricity;
an insulating member mounted between the housing and the transparent body and enclosed around the electric wire to prevent from incurring a static electricity leakage from the housing and the transparent body;
the control unit is mounted on the housing of the support unit to control operation of the sphere and the electric wire of the support unit;
the power supply unit is mounted on the housing of the support unit and electrically connected to the control unit to provide an electric power to the electric wire of the support unit by operation of the control unit.

2. The gear lever assembly of claim 1, wherein the control unit includes:
a circuit board mounted in the housing of the support unit and electrically connected to the electric wire of the support unit;
a transformer mounted in the housing of the support unit and electrically connected between the circuit board and a second end of the electric wire of the support unit;
a control switch mounted on the housing of the support unit and electrically connected to the circuit board to turn on/off an electric connection between the circuit board and the electric wire of the support unit.

3. The gear lever assembly of claim 2, wherein the power supply unit includes:
a socket mounted in the housing of the support unit and electrically connected to the circuit board of the control unit;
a plug detachably mounted on the housing of the support unit and electrically connected to the socket to provide an electric power through the socket into the circuit board of the control unit.

4. The gear lever assembly of claim 1, wherein the transparent body of the support unit has an inner portion provided with a receiving chamber to receive an insert gas.

5. The gear lever assembly of claim 4, wherein the sphere of the support unit is located at a central portion of the transparent body and is encompassed by the insert gas of the receiving chamber of the transparent body.

6. The gear lever assembly of claim 1, wherein the transparent body of the support unit has a substantially spherical profile.

7. The gear lever assembly of claim 2, wherein the circuit board of the control unit functions to isolate and regulate the static electricity.

8. The gear lever assembly of claim 1, wherein the transparent body of the support unit has a shape of a skull.

9. The gear lever assembly of claim 4, wherein the transparent body of the support unit has a side provided with an elongate receiving space to receive the sphere, the electric wire and the insulating member.

10. The gear lever assembly of claim 9, wherein the receiving space of the transparent body extends from a periphery of the transparent body to a center of the transparent body.

11. The gear lever assembly of claim 9, wherein the receiving space of the transparent body is encompassed by the receiving chamber.

12. The gear lever assembly of claim 9, wherein the housing of the support unit has a lower end secured on the gear lever and an upper end provided with an opening for mounting the transparent body.

13. The gear lever assembly of claim 12, wherein the receiving space of the transparent body is connected to the opening of the housing.

14. The gear lever assembly of claim 2, wherein the transformer of the control unit is located above the circuit board of the control unit.

15. The gear lever assembly of claim 3, wherein the socket of the power supply unit is located under the circuit board of the control unit.
